(19) United States
(12) Patent Application Publication
(10) Pub. No.: US 2010/0121840 A1
(43) Pub. Date: May 13, 2010

(54) QUERY DIFFICULTY ESTIMATION

(75) Inventors: Vanessa MURDOCK, Barcelona Catalunya (ES); Claudia HAUFF, Enschede (NL)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/269,732

(22) Filed: Nov. 12, 2008

(51) Int. Cl. G06F 17/30; G06G 7/48

(52) U.S. Cl. 707/722; 703/13; 707/E17.136

(57) ABSTRACT

In one embodiment, a method for estimating search query precision is provided, the method comprising: receiving a search query, wherein the search query contains one or more terms; retrieving documents from a collection based on the search query, wherein the retrieving includes only retrieving documents that contain all the terms of the search query; creating a query language model based on the retrieved documents; calculating a divergence between the query language model and the collection; and estimating search query precision based on the divergence, wherein the higher the divergence the more precise the search query.

### BACKGROUND

Query performance estimation has many applications in a variety of information retrieval (IR) areas such as improving retrieval consistency, query refinement, and distributed IR. Due to the importance of this problem, this area has become in increasingly investigated branch of research.

Query performance estimation aims to estimate whether the ranked list returned for a query has a high retrieval effectiveness (“easy” queries) or a low retrieval effectiveness (“difficult” queries), for a given document collection. High retrieval effectiveness queries are ones that contain relevant documents among the top retrieved documents, whereas low retrieval effectiveness queries are ones that do not contain relevant documents among the top retrieved documents. Such an estimation based on the queries and search engine results is a useful tool for search engines. An accurate estimate of the quality of search engine results can allow the search engine to decide, for example, to which queries to apply query expansion, suggest alternative search terms, adjust sponsored results, or return results from specialized collections.

Accurate query estimation can help the user to better understand how to find information in large scale collections such as the World Wide Web. The search engine can adjust its results based on the performance estimation, possibly searching a second collection or adding results to the current list if necessary to better serve the user.

Query performance estimation or prediction algorithms fall into two general categories: pre-retrieval prediction and post-retrieval estimation. In pre-retrieval prediction, the query is evaluated and query performance prediction performed prior to the retrieval step (i.e., without considering the ranked list of results, and therefore prediction). The advantage of such algorithms is that they can be computed quickly, using statistics that are available from the collection or query history, before the search engine makes the computational expense of actually producing the raking. A disadvantage of such predictions, however, is that by not taking into account the specific retrieval algorithms, the predictions may not be as accurate.

Post-retrieval estimation algorithms are more complex. They rely on knowledge regarding the ranked list of results (and thus estimate retrieval quality). They typically either compare the ranked list to the collection as a whole, or to different rankings produced by massaging the query or documents.

While query estimation algorithms have been shown to work well on various text retrieval conference (TREC) test collections, such as on limited collections like newspaper databases, they generally fail on larger collections such as the World Wide Web. The reasons for this failure are not well understood.

Per-retrieval algorithms take into account either the frequencies of the query terms in the collection, such as in Averaged Inverse Document Frequency (IDF), Query Scope, or Simplified Clarity Score algorithms, or the co-occurrence of query terms in the collection, such as in the Averaged Pointwise Mutual Information (PMI) algorithm.

Averaged IDF takes the average inverse document frequency over all query terms as follows:

$$av I D F ( Q ) = \frac{1}{m} {\sum }_{i = 1}^{m} log \frac{\vert C \vert}{\vert {D}_{{q}_{i}} \vert}$$

where Q is a query composed of m terms qᵢ, |C| is the number of documents in the collection, and |D_{qi}| is the number of documents containing the term qᵢ. Queries with low frequency terms are predicted to achieve a better performance than queries with high frequency terms as such queries are considered to be more specific and thus easier to answer.

Query Scope bases the prediction on the number of documents in the collection that contain at least one of the query terms.

Simplified Clarity Score is similar to Averaged IDF, but instead of document frequencies it relies on term frequencies as follows:

$$S C S ( Q ) = {\sum }_{{q}_{i} ∈ Q}^{ } {P}_{ml} ( {q}_{i} \vert Q ) \times {log}_{2} \frac{{P}_{ml} ( {q}_{i} \vert Q )}{{P}_{coll} ( {q}_{i} )}$$

where Pₘₗ(qᵢ|Q) is the maximum likelihood estimator of qᵢ given Q and P_{coll}(qᵢ) is set as the term count of qᵢ in the collection divided by the total number of terms in the collection.

Averaged PMI measures the average mutual information of two query terms in the collection, averaged over all the query term pairs:

$$AvPMI ( Q ) = \frac{1}{\vert ( {q}_{i} , {q}_{j} ) \vert} {\sum }_{( {q}_{i} , {q}_{j} ) ∈ Q}^{ } {log}_{2} ( \frac{{P}_{coll} ( {q}_{i} , {q}_{j} )}{{P}_{coll} ( {q}_{i} ) {P}_{coll} ( {q}_{j} )} )$$

P_{coll}(qᵢ, qⱼ) is the probability that qᵢ and qⱼ appear in the same document. AvPMI is zero for single term queries.

What is needed is an effective and efficient web query estimation solution.

### SUMMARY

In one embodiment, a method for estimating search query precision is provided, the method comprising: receiving a search query, wherein the search query contains one or more terms; retrieving documents from a collection based on the search query, wherein the retrieving includes only retrieving documents that contain all the terms of the search query; creating a query language model based on the retrieved documents; calculating a divergence between the query language model and the collection; and estimating search query precision based on the divergence, wherein the higher the divergence the more precise the search query.

In another embodiment, a method for estimating search query precision is provided, the method comprising: receiving a search query, wherein the search query contains one or more terms; retrieving documents from a collection based on the search query; determining the frequency of occurrence of each of the terms in the collection; creating a query language model based on a subset of the retrieved documents, wherein the subset is based on minimizing the contribution of terms having a high frequency in the collection; calculating a divergence between the query language model and the collection; and estimating search query precision based on the divergence, wherein the higher the divergence the more precise the search query.

In another embodiment, a system is provided comprising: one or more client devices; and a server configured to: receive a search query, wherein the search query contains one or more terms; retrieve documents from a collection based on the search query, wherein the retrieving includes only retrieving documents that contain all the terms of the search query; create a query language model based on the retrieved documents; calculate a divergence between the query language model and the collection; and estimate search query precision based on the divergence, wherein the higher the divergence the more precise the search query.

In another embodiment, a system is provided comprising: one or more client devices; and a server configured to: receive a search query, wherein the search query contains one or more terms; retrieve documents from a collection based on the search query; determine the frequency of occurrence of each of the terms in the collection; create a query language model based on a subset of the retrieved documents, wherein the subset is based on minimizing the contribution of terms having a high frequency in the collection; calculate a divergence between the query language model and the collection; and estimate search query precision based on the divergence, wherein the higher the divergence the more precise the search query.

In another embodiment, an apparatus for estimating search query precision is provided, the apparatus comprising: means for receiving a search query, wherein the search query contains one or more terms; means for retrieving documents from a collection based on the search query, wherein the retrieving includes only retrieving documents that contain all the terms of the search query; means for creating a query language model based on the retrieved documents; means for calculating a divergence between the query language model and the collection; and means for estimating search query precision based on the divergence, wherein the higher the divergence the more precise the search query.

In another embodiment, an apparatus for estimating search query precision is provided, the apparatus comprising: means for receiving a search query, wherein the search query contains one or more terms; means for retrieving documents from a collection based on the search query; means for determining the frequency of occurrence of each of the terms in the collection; means for creating a query language model based on a subset of the retrieved documents, wherein the subset is based on minimizing the contribution of terms having a high frequency in the collection; means for calculating a divergence between the query language model and the collection; and means for estimating search query precision based on the divergence, wherein the higher the divergence the more precise the search query.

### BRIEF DESCRIPTION OF THE DRAWINGS

FIG. 1 is a flow diagram illustrating a method for estimating search query precision in accordance with an embodiment of the present invention.

FIG. 2 is a flow diagram illustrating a method for estimating search query precision in accordance with another embodiment of the present invention.

FIG. 3 is an exemplary network diagram illustrating some of the platforms that may be employed with various embodiments of the invention.

### DETAILED DESCRIPTION OF EMBODIMENTS OF THE INVENTION

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

Clarity Score is a post-retrieval algorithm that measures a query's ambiguity towards a collection. The approach is based on the intuition that the top ranked results returned for an unambiguous query will be topically cohesive and terms particular to the topic will appear with high frequency. The term distribution of an ambiguous query, on the other hand, is assumed to be more similar to the collection distribution, as the top ranked documents cover a variety of topics. For example, a query for “artists who dies in the 1700's) is likely to perform poorly as keyword-based retrieval approaches will find documents with he terms “artist,” “die” or “1700” in them, which includes a broad range of topics. An extension of Clarity Score takes into account the temporal profiles of the queries.

In order to compute the Clarity Score, the ranked list of documents returned for a given query are used to create a query language model where terms that often co-occur in documents with query terms receive higher probabilities:

$${P}_{qm} ( w ) = {\sum }_{D ∈ R} P ( w \vert D ) P ( D \vert Q )$$

R is the set of retrieved documents, w is a term in the vocabulary, D is a document, and Q is a query. In the query model, P (D|Q) is estimated using Bayesian inversion:

P(D|Q)=P(Q|D)P(D)

where the prior probability of a document P(D) is zero for documents containing no query terms.

Typically, the probability estimations are smoothed to give non-zero probability to terms not appearing in the query, by redistributing some of the collection probability mass:

$$\begin{matrix}P ( D \vert Q ) = P ( Q \vert D ) P ( D ) \\ = P ( D ) {\prod }_{i} P ( {q}_{i} \vert D ) \\ \approx P ( D ) {\prod }_{i} λ P ( {q}_{i} \vert D ) + ( 1 - λ ) P ( {q}_{i} \vert C )\end{matrix}$$

where P(qᵢ|C) is the probability of the ith term in the query, given the collection, and λ is a smoothing parameter. The parameter λ is constant for all query terms, and is typically determined empirically on a separate test collection.

The Clarity Score itself is the Kullback-Leibler (KL) divergence between the query language model P_{qm} and the collection language model P_{coll}:

$${D}_{KL} ( {P}_{qm} \vert \vert {P}_{coll} ) = {\sum }_{w ∈ V} {P}_{qm} ( w ) log \frac{{P}_{qm} ( w )}{{P}_{coll} ( w )}$$

The larger the KL score, the more distinct is the query language model from the collection language model. The only parameter of Clarity Score is the number of top ranked documents (the number of feedback documents) from which to sample to the query language model.

Another modified approach is to compare the ranked list of the original query with the ranked lists of the query's constituent terms. The idea behind this approach is that, for well performing queries, the result list does not change considerably if only a subset of query terms is used. Machine learning approaches may be used to achieve this, exploiting several features, among others the overlap in the top ranked documents between the original query and the subqueries, the score of the top ranked document and the number of query terms. An offshoot of this is to consider a query to be difficult if different ranking functions retrieve diverse ranked lists. If the overlap between the top ranked documents is large across all ranked lists, the query is deemed to be easy. For evaluation purposes, the estimation scores are correlated against the average and median precision created from all submitted query runs.

Weighted Information Gain measures the change in information about the quality of retrieval from an imaginary state that only an average document is retrieved (estimated any the collection model) to a posterior state that the actual search results are observed. Query Feedback frames query difficulty estimation as a communication channel problem. The input is query Q, the channel is the retrieval system, and the ranked list L is the noisy output of the channels. From the ranked list L, a new query Q′ is generated, a second ranking L′ is retrieved with Q′ as input and the overlap between L and L′ is used as a prediction score. The lower the overlap between the two rankings, the higher the query drift and thus the more difficult the query.

One problem that arises with Clarity Score is that the difficulty estimation performance depends on the number of feedback documents (the documents retrieved in the initial search and used as the basis for the query language model). The number of feedback documents is fixed, usually set by an administrator. Research has even suggested that the exact number of feedback documents used is of no particular importance and 500 feedback documents is sufficient. The inventors of the present application, however, propose that the number of feedback documents is important, and have performed experiments showing that the prediction performance does indeed depend on the number of feedback documents.

In an embodiment of the present invention, the number of feedback documents is dynamically set based, at least partially, on the search results themselves. If the query language model is created from a mixture of topically relevant and off-topic documents, its score will be lower compared to a query language model that is made up only of topically relevant documents, due to the increase in vocabulary size of the language model and the added noise. For example, for the query “Jennifer Aniston”, if the query language model not only includes documents containing both terms, but also documents containing the term “Jennifer” but not the term “Aniston,” a focused query is essentially turned into an ambiguous one, since added to the query language model are the same documents that would have been returned for the query “Jennifer.” The term “Aniston,” on the other hand, is an important term in the query as it disambiguates the term “Jennifer.” Thus, preferably the query language model should be created from documents containing “Jennifer Aniston.”

In a retrieval setting, it is assumed that there is vocabulary mismatch between how users express their need and how a relevant document expresses the same information. Thus, in an embodiment of the present invention, the probability estimates may be smoothed for unseen terms, or to assign probabilities to terms that are not in the query, in the interest of casting a wider net in hopes of finding information to satisfy the user.

It should be noted that in estimating the difficulty of a given query, the system is not interested in estimating the difficulty of the query the user might have submitted. Instead, it is operating on the terms at hand, and only cares about the ambiguity of the query composed of these exact terms. Every term in the query is important for the purpose of predicting the ambiguity of the query, but the system still operates on the specific query, and not an unspecified need for information.

Instead of fixing λ to a single value over the entire vocabulary as in Clarity Score described above, in an embodiment of the present invention a smoothing weight specific to each query term is used as follows:

$$P ( D \vert Q ) \approx P ( D ) {\prod }_{i} {λ}_{i} P ( {q}_{i} \vert D ) + ( 1 - {λ}_{i} ) P ( {q}_{i} \vert C )$$

Setting λᵢ=1 for all query terms qi enforces the constraint that all query terms must be present in the document, or the document will receive a score of zero. One issue with this formulation for estimating a language model is that the language model, although it reflects documents containing the mandatory terms, itself is no longer smoothed. For this reason, an additional smoothing parameter β that determines the amount of smoothing with the collection language model:

$$P ( D \vert Q ) \approx P ( D ) {\prod }_{i} {λ}_{i} ( β P ( {q}_{i} \vert D ) + ( 1 - β ) P ( {q}_{i} \vert C ) ) + ( 1 - {λ}_{i} ) P ( {q}_{i} \vert C )$$

Thus, the query language model may be created only from documents that contain all query terms. This sets the number of feedback documents dynamically and automatically: for each query, the number of feedback documents utilized in the generation of the query language model is equal to the number of documents in the collection containing all query terms.

In some instances, there may be no documents in the collection that contain all query terms. In such cases, an embodiment of the present invention allows for the constraint on λᵢ=1 to be relaxed and documents containing m-1 query terms included in the query language model generation. In a further embodiment of the present invention, when this occurs, the constraint is only partially relaxed in that only documents with the most unique of the m-1 query terms are added to the feedback document list. For example, if the query “Jennifer Aniston” revealed no documents, then documents containing the term “Aniston” without “Jennifer” (and not documents containing the term “Jennifer” without “Aniston”) are added to the feedback document list.

Furthermore, the performance of Clarity Score depends on the initial retrieval run. In the language modeling approach to information retrieval, Clarity Score performs better with algorithms relying on a small amount of smoothing. Since increased smoothing often increases retrieval effectiveness (measured in mean average precision, retrieval with more smoothing is preferred. Hence, it is desirable to improve on Clarity Score for retrieval runs with more smoothing. Increasing smoothing also increases the influence of high frequency terms on the KL divergence calculation, despite the fact that terms with a high document frequency do not aid in retrieval and therefore should not have a strong influence on the prediction score.

Thus, in an embodiment of the present invention, the contribution of terms that have a high document frequency in the collection is minimized. One proposed solution uses expectation maximization (EM) to learn a separate weight for each of the terms in the set of feedback documents. In doing so, noise is reduced from terms that are frequent in the collection, as they have less power to distinguish relevant from nonrelevant documents. The effect is to select the terms that are frequent in the set of feedback documents, but infrequent in the collection as a whole.

Web retrieval requires speed. Running EM to convergence, although desirable, can be computationally impractical at times. As such, to approximate the effect of selecting terms frequent in the query model, but infrequent in the collection, an embodiment of the present invention selects the terms from the set of feedback documents that appear in N % of the collection. In one embodiment, N is either 1, 10, or 100.

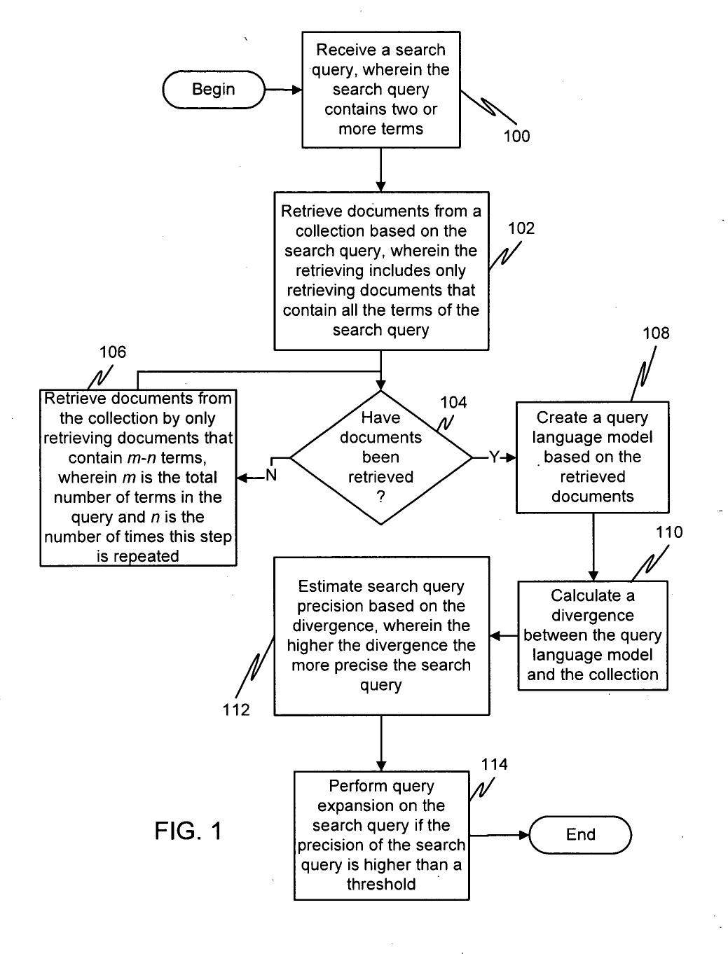

FIG. 1 is a flow diagram illustrating a method for estimating search query precision in accordance with an embodiment of the present invention. This method corresponds at least partially to the solution of setting the number of feedback documents automatically as described above. At 100, a search query is received, wherein the search query contains one or more terms. At 102, documents are retrieved from a collection based on the search query, wherein the retrieving includes only retrieving documents that contain all the terms of the search query (retrieving documents that contain m terms wherein m is all the terms in the query). At 104, it is determined if there are no documents retrieved. If so, then at 106, documents are retrieved from the collection based on the search query, wherein the retrieving includes only retrieving documents that contain m-n terms, wherein n is the number of times step 106 is repeated (i.e., the number of times through the loop). So the first time 106 is executed, documents that contain m-1 terms are retrieved, the second time m-2, and so on. This process then repeats back to 104, thus making step 106 repeat until documents are actually retrieved.

At 108, a query language model is created based on the retrieved documents. This may include applying a smoothing weight to each query term. At 110, a divergence is calculated between the query language model and the collection. At 112, search query precision is estimated based on the divergence, wherein the higher the divergence the more precise the search query. At 114, query expansion may be performed on the search query if the precision of the search query is higher than a threshold.

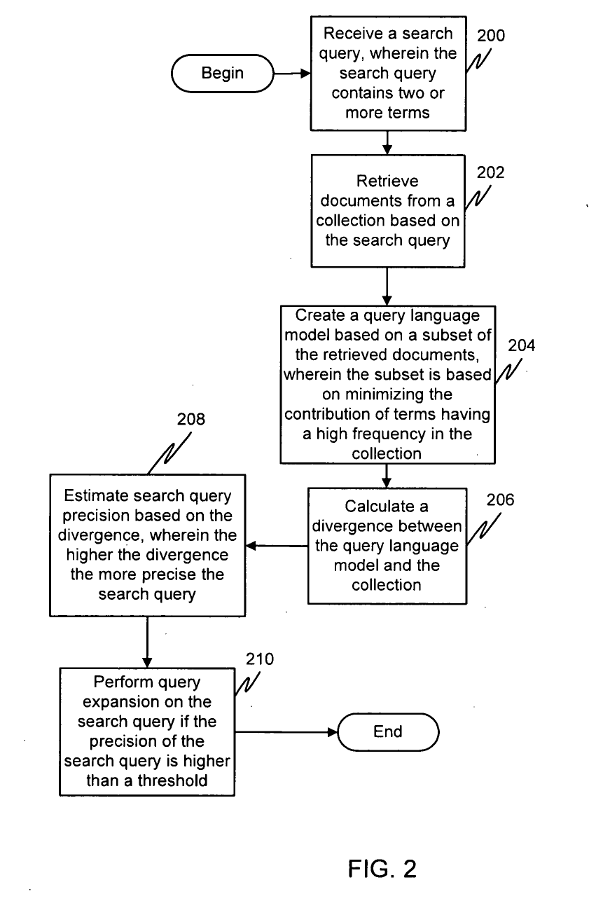

FIG. 2 is a flow diagram illustrating a method for estimating search query precision in accordance with another embodiment of the present invention. This method corresponds at least partially to the solution of frequency-dependent term selection as described above. At 200, a search query is received, wherein the search query contains one or more terms. At 202, documents are retrieved from a collection based on the search query. At 204, a query language model is created based on a subset of the retrieved documents, wherein the subset is based on minimizing the contribution of terms having a high frequency in the collection. This minimizing may be performed by determining one or more of the terms to minimize by selecting those terms that appear in N % of the collection (wherein N is, for example, 1, 10, or 100). and selecting only documents from the collection that contain one or more of the non-minimized terms.

At 206, a divergence is calculated between the query language model and the collection. At 208, search query precision is estimated based on the divergence, wherein the higher the divergence the more precise the search query. At 210, query expansion may be performed on the search query if the precision of the search query is higher than a threshold.

It should be noted that while the methods of FIGS. 1 and 2 may be performed separately, embodiments are also foreseen wherein both methods are executed together, resulting in both the number of feedback documents being set automatically and the term selections being made frequency-dependent.

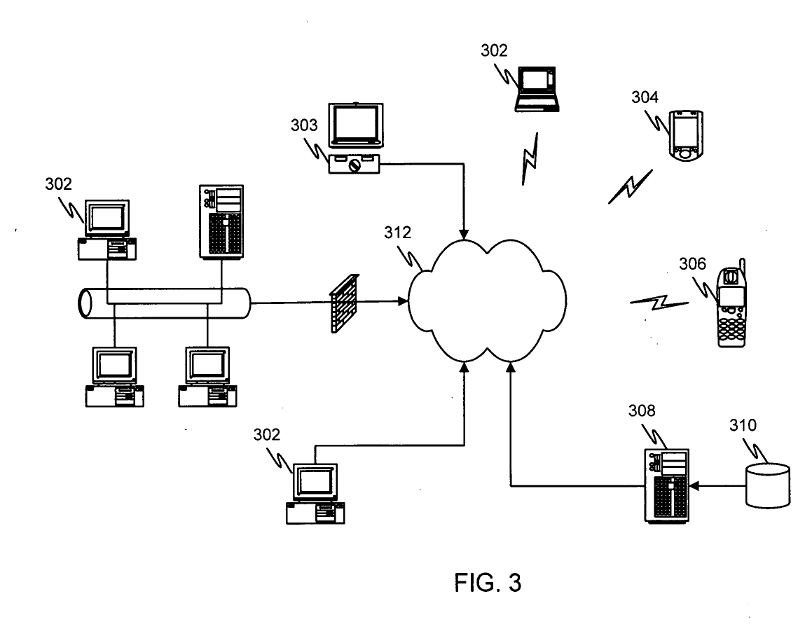

It should also be noted that embodiments of the present invention may be implemented on any computing platform and in any network topology in which presentation of search results is a useful functionality. For example and as illustrated in FIG. 3, implementations are contemplated in which the invention is implemented in a network containing personal computers 302, media computing platforms 303 (e.g., cable and satellite set top boxes with navigation and recording capabilities (e.g., Tivo)), handheld computing devices (e.g., PDAs) 304, cell phones 306, or any other type of portable communication platform. Users of these devices may navigate the network and enter input in response to the displaying of captcha on local displays, and this information may be collected by server 308. Server 308 (or any of a variety of computing platforms) may include a memory, a processor, and a communications component and may then utilize the various techniques described above. The processor of the server 308 may be configured to run, for example, all of the processes described in FIGS. 1 and 2. Any of the client devices 302, 303, 304, 306 may be alternatively be configured to run, for example, some or all of the processes described in FIGS. 1 and 2. Server 308 may be coupled to a memory 310, which may store the mappings between languages. Applications may be resident on such devices, e.g., as part of a browser or other application, or be served up from a remote site, e.g., in a Web page (also represented by server 308 and memory 310). The invention may also be practiced in a wide variety of network environments (represented by network 312), e.g., TCP/IP-based networks, telecommunications networks, wireless networks, etc. The invention may also be tangibly embodied in one or more program storage devices as a series of instructions readable by a computer (i.e., in a computer readable medium).

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method for estimating search query precision, the method comprising:
receiving a search query, wherein the search query contains one or more terms;
retrieving documents from a collection based on the search query, wherein the retrieving includes only retrieving documents that contain all the terms of the search query;
creating a query language model based on the retrieved documents;
calculating a divergence between the query language model and the collection; and
estimating search query precision based on the divergence, wherein the higher the divergence the more precise the search query.

2. The method of claim 1, further comprising:
if there are no documents in the collection that contain all the terms of the search query, retrieving documents from the collection based on the search query, wherein the retrieving includes only retrieving documents that contain all but one of the terms of the search query.

3. The method of claim 1, further comprising:
performing query expansion on the search query if the precision of the search query is higher than a threshold.

4. The method of claim 1, wherein the creating a query language model includes applying a smoothing weight to each query term.

5. The method of claim 4, wherein the creating a query language model further comprise computing:
$${P}_{qm} ( w ) = {\sum }_{D ∈ R} P ( w \vert D ) P ( D \vert Q )$$
wherein R is a set of retrieved documents, w is a term in a vocabulary, D is a document, and Q is a query.

6. The method of claim 5, wherein the calculating a divergence includes calculating
$${D}_{KL} ( {P}_{qm} \vert \vert {P}_{coll} ) = {\sum }_{w ∈ V}^{ } {P}_{qm} ( w ) log \frac{{P}_{qm} ( w )}{{P}_{coll} ( w )}$$
wherein P_{qm} is a query language model and P_{coll} is a collection language model
$${D}_{KL} ( {P}_{qm} \vert \vert {P}_{coll} ) = {\sum }_{w ∈ V}^{ } {P}_{qm} ( w ) log \frac{{P}_{qm} ( w )}{{P}_{coll} ( w )}$$

7. A method for estimating search query precision, the method comprising:
receiving a search query, wherein the search query contains one or more terms;
retrieving documents from a collection based on the search query;
determining the frequency of occurrence of each of the terms in the collection;
creating a query language model based on a subset of the retrieved documents, wherein the subset is based on minimizing the contribution of terms having a high frequency in the collection;
calculating a divergence between the query language model and the collection; and
estimating search query precision based on the divergence, wherein the higher the divergence the more precise the search query.

8. The method of claim 7, wherein the minimizing includes:
determining one or more of the terms to minimize by selecting those terms that appear in N % of the collection; and
selecting only documents from the collection that contain one or more of the non-minimized terms.

9. The method of claim 8, wherein is N is 1, 10, or 100.

10. The method of claim 7, further comprising:
performing query expansion on the search query if the precision of the search query is higher than a threshold.

11. A system comprising:
one or more client devices; and
a server configured to:
receive a search query, wherein the search query contains one or more terms;
retrieve documents from a collection based on the search query, wherein the retrieving includes only retrieving documents that contain all the terms of the search query;
create a query language model based on the retrieved documents;
calculate a divergence between the query language model and the collection; and
estimate search query precision based on the divergence, wherein the higher the divergence the more precise the search query.

12. A system comprising:
one or more client devices; and
a server configured to:
receive a search query, wherein the search query contains one or more terms;
retrieve documents from a collection based on the search query;
determine the frequency of occurrence of each of the terms in the collection;
create a query language model based on a subset of the retrieved documents, wherein the subset is based on minimizing the contribution of terms having a high frequency in the collection;
calculate a divergence between the query language model and the collection; and
estimate search query precision based on the divergence, wherein the higher the divergence the more precise the search query.

13. An apparatus for estimating search query precision, the apparatus comprising:
means for receiving a search query, wherein the search query contains one or more terms;
means for retrieving documents from a collection based on the search query, wherein the retrieving includes only retrieving documents that contain all the terms of the search query;
means for creating a query language model based on the retrieved documents;
means for calculating a divergence between the query language model and the collection; and
means for estimating search query precision based on the divergence, wherein the higher the divergence the more precise the search query.

14. An apparatus for estimating search query precision, the apparatus comprising:
means for receiving a search query, wherein the search query contains one or more terms;
means for retrieving documents from a collection based on the search query;
means for determining the frequency of occurrence of each of the terms in the collection;
means for creating a query language model based on a subset of the retrieved documents, wherein the subset is based on minimizing the contribution of terms having a high frequency in the collection;
means for calculating a divergence between the query language model and the collection; and
means for estimating search query precision based on the divergence, wherein the higher the divergence the more precise the search query.
